(19) United States
(12) Patent Application Publication
(10) Pub. No.: US 2007/0029745 A1
(43) Pub. Date: Feb. 8, 2007

(54) Shopping cart carrier/attachment/holder/container

(76) Inventor: Jacqueline Lee Ursettie, Wauconda, IL (US)

Correspondence Address: Jacqueline L. Ursettie, 360 Oakwood Road, Wauconda, IL, 60084, US

(21) Appl. No.: 11/030,744

(22) Filed: Aug. 5, 2005

(51) Int. Cl. B62D 39/00

(52) U.S. Cl. 280/33.992

(57) ABSTRACT

An attachment/side car to a shopping cart/basket attached to the framework of the cart/basket in a perpendicular position which enables the consumer to carry/transport tall, long items such as drapery rods, fishing poles, wood trim, shovels, rakes purchase throughout the store safely avoiding injury to one self or other consumers.

### BACKGROUND OF THE INVENTION

This invention is an attachment to shopping carts/carriers designed for the safety of the consumer to assist/aid in the transporting of items that are outside of the range of the basket of the shopping cart/carrier in an upright/perpendicular position to the cart thus preventing injury to customer and consumers.

As a consumer, one is faced with how to transport items once purchased from the register to their vehicle. As a former cashier, I realized that there must be a better way for the items, such as curtain rods, shovels, brooms, trim pieces to be carried throughout the store and not cause injury or harm to the customer as well as other consumers of the store.

I have designed a sidecar attachment that would be attached to a shopping cart to remedy this safety issue.

There are currently patents on file for shopping cart attachments, but this is for the handle bar that would hold coupons, drinks, etc.

There is also a golf cart attachment that would support umbrellas or elongated items such as a crutch. This is done with pin engagements.

My design is simple. This attachment or side cart is attached to the framework of the shopping cart. It is designed to be of rigid construction able to with stand the impact of another cart or other solid structure. It would be made out of material that could withstand varying degrees of temperatures for various environments. For example, for carriers that would be moved to and from freezers.

The sidecar can be permanently attached to the cart or removable. It should be no longer than the framework of the shopping cart to enable free movement of the wheels and not to obstruct the view. As attached to the handle area of the frame, the consumer could maneuver the aisles and not have items poking through the front or over the shopping cart causing potential injury to consumers.

The sidecar can be of solid construction or open weave to allow drainage. The opening at the top would allow for items to be dropped into the sidecar and not fall through the bottom since it would be closed construction.

There are instances when the side car would have an internal sleeve that could be extended should items need more support such as 6-8 foot moldings, drapery rods, shovels.

Thus, there is a need and necessity for a sidecar shopping cart attachment that would prevent serious injuries to consumers, such as eye or facial, by being able to transport merchandise safely from the shopping aisle to the register to a vehicle for transport.

### BRIEF SUMMARY OF THE INVENTION

The invention is an attachment/side car carrier that is attached to the framework of a shopping cart which enables the consumer to safely carry items for purchase throughout the store from the aisles throughout the store to registers and finally to the vehicle.

The consumer would have a place to put drapery rods, fishing poles, shovels, shower curtain rods, that can be securely in a container/attachment and move freely about the store without fear of the pole or rod poking another customer. Maneuvering through the aisle will be less of a challenge. The sidecar must be impact resistant, able to with stand varying temperature such as a freezer, with an expandable sleeve for extension for longer items.

Construction could be from solid to an open weave but again, impact resistant.

### BRIEF DESCRIPTION OF THE SEVERAL VIEWS OF THE DRAWING

FIG. 1 shows a first view of a side car attached to a shopping cart.

FIG. 2 show a first view of a side car with an extension sleeve.

### DETAILED DESCRIPTION OF THE INVENTION

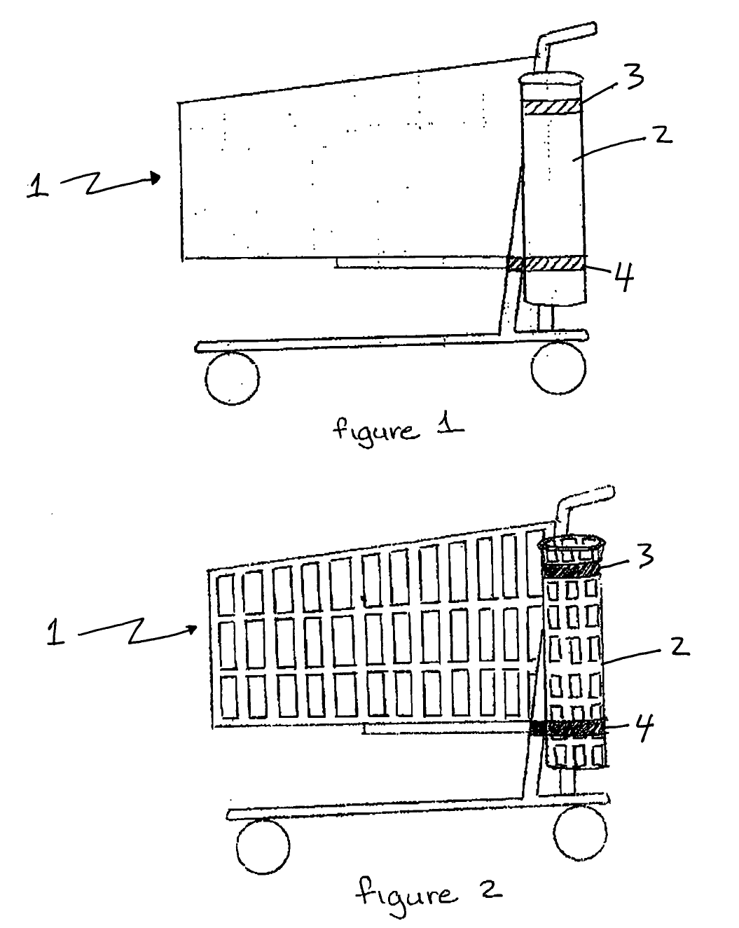

The basic premise of this invention is safety for the consumer. As shown in FIG. 1, an attachment or sidecar 2 is attached to a shopping cart 1 enabling the consumer to safely maneuver items throughout the store.

Shopping carts/baskets are designed for ease to the consumer to carry purchases, items up and down aisles while shopping. So the groceries are safe and don't fall over into aisle as you shop. You can stop in an aisle and read labels and make decisions as to what to purchase.

However, where and how does one carry/transport a mop or a shovel or fishing pole or trim molding. If you try and put it into a shopping cart/basket, it will hang over the basket. As a consumer, you have to constantly hold on to the item while trying to shop and not poke your own eyes or that of another consumer.

The design is for the side car/attachment to be installed onto the framework of the shopping cart/carrier. As shown in FIG. 1, side car 2 can be attached near the handle of shopping cart 1. In an alternate embodiment, side car 2 can be attached to shopping cart 1 near the front end of shopping cart 1, and may be placed inside of the shopping cart or outside of the shopping cart. The primary consideration for placement is that the side car 2 be substantially vertical.

Side car 2 should be constructed of a solid, impact resistant material that would withstand the impact of a shopping cart/basket. Preferably, side car 2 would be rigidly secured to the framework of the shopping cart 1.

Side car 2 should be capable of withstanding varying degrees of temperature. This would enable it to be taken into a freezer area or into an area where the temperature would be warmer as in manufacturing, welding, mechanical area.

By making the sidecar 2 completely solid construction on the sides and the bottom, items would not slip out of the sidecar 2. In another application, it would be more advantageous for side car 2 to have an open-weave construction, allowing drainage, which may be required in landscaping operations.

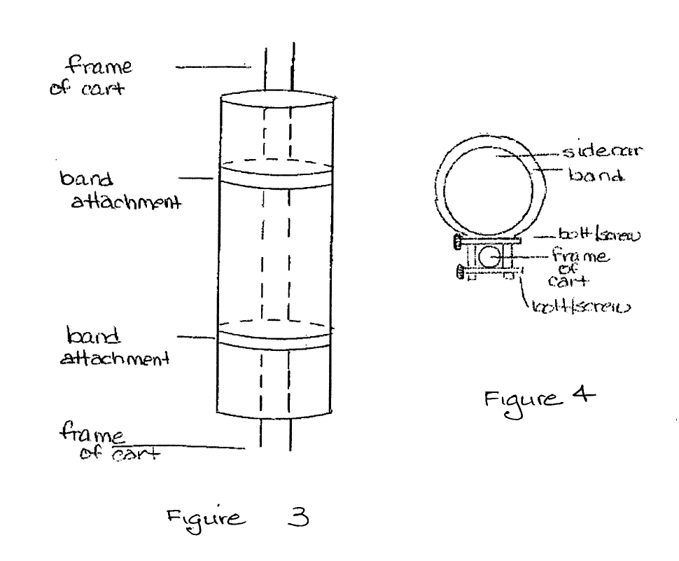

As show in FIG. 2, side car 2 may be fitted with an extension sleeve 3, which would allow longer or taller items to be safely and securely transported. Alternately, side car 2 may have an open bottom allowing for longer or taller items.

In an alternate embodiment, the diameter of side car 2 would be adjustable to allow for items of different widths or diameters to be more securely held by side car 2. Side car 2 could be adjusted by tightening the entire side car 2 or tightening a portion of side car 2, for example the top or middle of the side car 2.

In an alternate embodiment, side car 2 could be removable from shopping cart 1, allowing side car 2 to be transported and mounted for storage of items.

Generally, side car 2 would be secured above the wheels of the shopping cart 1 to enable freedom of movement of the wheels. A secure method for attaching side car 2 to shopping cart 1 would be to have two would be two (2) points of attachment, one at the highest point of the shopping cart 1 and the other closer to the ground, for example two to three inches above the wheels.

To keep the side car 2 perpendicular to the shopping cart 1, brackets may be used to support side car 1 with supports at the top and bottom for attachment. The top bracket would be shorter in length than the lower bracket to keep side car 2 generally in the upright position.

What is claimed is:

1. An assembly, comprising:
a shopping cart; and
an attachment for holding tall items;
wherein said attachment is attached to said shopping cart such that said items are held generally vertically and wherein said attachment is secured to said shopping cart at first point near the base of said shopping cart and at a second point near the handle of said shopping cart.

2. The assembly of claim 1 wherein said attachment has an adjustable diameter.

3. The assembly of claim 1 wherein said attachment is removable from said shopping cart.

4. The assembly of claim 1 wherein said attachment further has a side surface and wherein said side surface is of a solid construction.

5. The assembly of claim 1 wherein said attachment further has a side surface and wherein said side surface is of an open weave construction.

6. (canceled)

7. (canceled)

8. The assembly of claim 1 wherein the tops of said items are below eye level.

9. (canceled)
